(19) United States
(12) Patent Application Publication
(10) Pub. No.: US 2025/0229599 A1
(43) Pub. Date: Jul. 17, 2025

(54) FLAP SYSTEM FOR A HEATING, VENTILATION AND AIR-CONDITIONING (HVAC) UNIT FOR CIRCULATING-AIR/FRESH-AIR CONTROL AND HVAC UNIT

(71) Applicant: Hanon Systems, Daejeon (KR)

(72) Inventors: Ralph Wiesmann, Euskirchen (DE); Martin Heiko, Köln (DE); Martin Paul Nowak, Rösrath (DE)

(21) Appl. No.: 18/853,572

(22) PCT Filed: Jun. 12, 2023
(86) PCT No.: PCT/KR2023/007990

§ 371 Date: Oct. 2, 2024

(30) Foreign Application Priority Data
Aug. 9, 2022 (DE) 102022120057.4

(51) Int. Cl. B60H 1/00

(52) U.S. Cl. CPC B60H 1/00678; B60H 1/00021; B60H 1/00849; B60H 2001/00092; B60H 2001/00721

(57) ABSTRACT

A flap system for a heating, ventilation and air-conditioning unit for circulating-air/fresh-air control in a motor vehicle, the HVAC unit having flow ducts for circulating air and for fresh air and a mixing chamber in which circulating air and fresh air are mixed with one another for ventilating a vehicle interior, the flap system having two rotary flaps, each adjustable about an axis of rotation, and an actuator, by which one of the two rotary flaps is driven directly for adjustment, and wherein the other rotary flap is a circulating air rotary flap associated with the flow channel for circulating air for influencing a circulating air flow.

### CROSS REFERENCE TO RELATED PATENT APPLICATIONS

This is a U.S. national phase patent application of PCT/KR2023/007990 filed Jun. 12, 2023, which claims the benefit of and priority to German Patent Application No. 10 2022 120 057.4 filed on Aug. 9, 2022, the entire contents of each of which are incorporated herein by reference for all purposes.

### TECHNICAL FIELD

The invention relates to a flap system for a heating, ventilation and air-conditioning unit (HVAC unit) for circulating-air/fresh-air control in a motor vehicle and an HVAC unit with a flap system for use in a motor vehicle for circulating-air/fresh-air control in the motor vehicle.

### BACKGROUND ART

Heating, ventilation and air-conditioning units (HVAC units) of motor vehicles usually incorporate a circulating air function. The circulating air function serves to prevent the introduction of odors and/or pollutants from the environment into the interior of the vehicle and also helps to reduce the energy consumption during the air conditioning. The energy savings are achieved by the fact that, due to the preconditioned air present in the vehicle, a lower temperature difference has to be overcome during the air conditioning in circulating air operation compared to the fresh air conditioning. However, continuous circulating air operation can also lead to problems. As an example, the risk of fogged windowpanes increases in circulating air operation due to an increase in air humidity. Furthermore, the air quality decreases due to the consumption of oxygen by the vehicle occupants in the vehicle cabin. A compromise solution which allows energy savings and adequate air quality is to operate the HVAC unit with partial air supply. As such, a mixture of fresh air and circulated air from the vehicle interior is provided and employed for ventilation of the vehicle interior. This method entails further challenges since, as the vehicle speed increases, a dynamic pressure can build up in the intake system of the HVAC unit. This dynamic pressure causes a partly undesirable increase in the air quantity conveyed. Compensation is only possible to a limited extent by reducing the fan output as the fan should be operated with a minimum output. Therefore, some HVAC systems additionally employ dynamic pressure compensation by having a reduced cross section of the fresh air opening in the air inlet. This reduced cross section is achieved by a further control flap (fresh air flap) for influencing the fresh air flow. Dynamic pressure compensation has proven particularly advantageous in partial air operation with mixed circulating air and fresh air, because in partial air operation, there is the risk that the high pressure causes fresh air to pass directly and unconditioned through an opening for the circulating air flow into the vehicle interior. This occurs at low fan output and thus at low air throughput, in particular. In this case, the intake vacuum of the fan of the HVAC unit is not sufficient to extract the pressurized fresh air. This may be counteracted with dynamic pressure compensation by a control flap.

In the solutions of HVAC units known to date, which are employed in various types of vehicles, a separate fresh air flap with a separate actuator is employed for dynamic pressure compensation to influence the fresh air flow. Thus, the fresh air flap is adjustable separately and independently of further flaps, for example the circulating air flap, but requires its own actuator, which is associated with additional costs. Other solutions utilize mechanical couplings between the fresh air flap and the circulating air flap, complex cam discs with slide guide tracks being employed to enable flap adjustment. As such, pins of levers are guided in the slide guide tracks, the levers being connected to the corresponding flaps. In this case, a link disc is driven by an actuator. As such, each flap is provided with its own link disc, via which a movement for adjustment is transmitted to a lever. Such mechanical couplings require complex transmissions or multiply articulated lever arrangements with cam discs and corresponding guide tracks, which are often accommodated in a separate housing and/or require a separate carrier plate due to their complexity. In the case of such a coupling of flaps, additional backlash is introduced in the drive. This has a negative effect on the accuracy of the adjustment of the partial air quantity and the dynamic pressure compensation. Additionally, the known solutions require a comparatively large installation space.

### SUMMARY

The object of the invention is to provide a simple, space-saving and more cost-effective flap system for a heating, ventilation and air-conditioning unit (HVAC unit) for circulating-air/fresh-air control with a dynamic pressure compensation function in a motor vehicle.

The object is achieved by a flap system having the features shown and described herein.

The flap system according to the invention is provided for a heating, ventilation and air-conditioning unit (HVAC unit) for circulating-air/fresh-air control in a motor vehicle, the HVAC unit having flow ducts for circulating air and for fresh air and a mixing chamber in which circulating air and fresh air can be mixed with one another for ventilating a vehicle interior. According to the invention, the flap system has two rotary flaps, adjustable about an axis of rotation, and an actuator, by which one of the two rotary flaps is driven directly for adjustment. A drive shaft of the directly driven rotary flap has a cam disc with a guide track in which a pendulum lever mechanically coupled to a drive lever of the further rotary flap is guided in such a way that a rotation of the cam disc effects an indirect drive for adjusting the further rotary flap. Due to the direct drive and the indirect drive dependent on the direct drive, one of the rotary flaps is movable in each case between a first closed position and a second closed position into an open position with only one actuator. According to the invention, one rotary flap is a fresh air rotary flap associated with the flow duct for fresh air for influencing a fresh air flow, wherein the other rotary flap is a circulating air rotary flap associated with the flow duct for circulating air for influencing a circulating air flow.

The mechanical coupling between the pendulum lever and the drive lever has the effect that the indirectly driven rotary flap, which may be the circulating air rotary flap, is adjustable without its own actuator as a function of an adjustment of the directly driven rotary flap, which may be the fresh air rotary flap. The combination of the elements of link disc, pendulum lever and drive lever is referred to as a cam gear. Accordingly, the cam gear has a link disc with a guide track and a pendulum lever guided in the guide track, which cooperates with a drive lever of a drive shaft of the rotary flap in such a way that a rotation of the link disc effects a rotational movement of the two rotary flaps.

According to the invention, the flow duct for the fresh air and the fresh air rotary flap are designed such that the fresh air flap has at least two closed positions, the fresh air flap being movable at least from a first closed position into an open position and from the open position into the first closed position or into a second closed position. In the closed positions, the flow ducts have flap stops.

The pendulum lever is rotatable about a pivot point and can be mounted on a housing wall of the HVAC unit.

The actuator can be an electrically powered motor. For the purposes of the invention, direct drive means that no transmission is arranged between the actuator and the rotary flap for driving the rotary flap.

The actuator being coupled directly to a rotary flap reduces or minimizes a motion backlash when adjusting this directly driven rotary flap, improving the precision when influencing the air flow. The actuator and the coupling between the actuator and the rotary flap are designed in such a way that the rotational movement of the rotary flap has nearly no motion backlash. Undesirable transmission noise is reduced by the direct drive.

In comparison to the known solutions, in which a separate cam gear with separate guide tracks is provided for each rotary flap, a separate cam gear for one of the two flaps is omitted in the solution according to the invention. Thus, the flap system according to the invention has a low complexity and can be manufactured with lower manufacturing effort.

To implement the two closed positions of the rotary flaps, flap stops can be designed in the flow ducts for fresh air and for circulating air. Further, the rotary flaps can be correspondingly designed geometrically and thus cooperate with the respective flow duct to ensure the desired closed positions.

According to a first embodiment of the flap system according to the invention, it can be provided that the mechanical coupling between the drive lever of the indirectly driven rotary flap and the pendulum lever is designed as interlocking toothing. As such, the opposite ends of the drive lever and of the pendulum lever can be partly designed as interlocking spur gears. This means that the opposite end faces have teeth which interlock to transmit force.

In a further advantageous embodiment of the flap system according to the invention, it can be provided that the mechanical coupling between the drive lever of the indirectly driven rotary flap and the pendulum lever is designed as an articulated connection, wherein the articulated connection is a pin-groove connection. The pin-groove connection enables an articulated pendulum movement of the components of drive lever and pendulum lever arranged in a stationary manner.

Furthermore, it can be provided that the mechanical coupling between the drive lever of the indirectly driven rotary flap and the pendulum lever is in the form of an articulated connection with a coupling. By using the coupling, the mechanical coupling has an additional joint, which is advantageous for the spatial arrangement of the rotary flaps. Thus, with the indirect drive, greater distances between the rotary flaps can be overcome, for example. On the other hand, this also enables arranging the rotary flaps in a very narrow space.

The course of the guide track can effect a translation between the adjusting movement between the directly driven rotary flap and the indirectly driven rotary flap. Accordingly, a course of the guide track can be predetermined in which an angular adjustment of the indirectly driven rotary flap during an angular adjustment of the rotary flap directly driven by rotation of the link disc is greater or less than the angular adjustment of the directly driven rotary flap. In addition, the axes of rotation of the two rotary flaps can have a predetermined angular offset. This angular offset can be adapted to the geometrical conditions of the flow ducts and the spatial arrangement of the rotary flaps.

Preferably, the rotary flaps each have separate drive shafts, wherein the drive shafts are mounted in the housing wall of the HVAC unit.

The link disc and the actuator can be arranged at the same end of the drive shaft of the directly driven rotary flap. According to another embodiment, however, an arrangement can also be provided in which the actuator is arranged at the opposite end of this drive shaft opposite the link disc. Thus, the actuator can be arranged on either end of the drive shaft. For connection to the actuator, the ends of the drive shaft can have toothed pins onto which the actuator can be placed.

According to a still further embodiment of the flap system according to the invention, it can be provided that the directly driven rotary flap and the indirectly driven rotary flap are spatially arranged and positioned relative to one another in such a way that the rotary flaps close against one another in at least one adjustment position in such a way that the flow duct for circulating air and the flow duct for fresh air are closed. Due to the rotary flaps closing against one another in an adjustment position, no additional flap stop is required for one of the two closed positions of the rotary flaps. The spatially compact arrangement of the rotary flaps further contributes to an even more compact and space-saving design.

The drive shafts for the rotary flaps, i.e., for the fresh air rotary flap and the circulating air rotary flap, can be mounted so as to pass through the housing wall of the HVAC unit, wherein the actuator and the link disc are arranged outside the housing wall of the HVAC unit. The actuator and the cam gear, i.e., the components for the direct drive and the indirect drive, being arranged outside the housing wall of the HVAC unit ensures easy access to the cam gear in the event of maintenance. Thus, the actuator and the components of the cam gear can be replaced in an easy manner without having to open the housing of the HVAC unit.

Advantageously, the course of the guide track can be designed in such a way that at least five different adjustment combinations of the rotary flaps are possible. Accordingly, in particular the course of the guide track of the link disc can be designed in such a way that the adjustment combinations explained below are able to be implemented. The directly driven rotary flap can be the fresh air rotary flap, wherein the indirectly driven rotary flap is the circulating air rotary flap. The following explains adjustment combinations for a constellation in which the directly driven rotary flap is the fresh air rotary flap, the indirectly driven rotary flap being the circulating air rotary flap. The guide track of the link disc produces a corresponding movement profile for the indirect drive for adjusting the circulating air rotary flap as a function of the adjustment of the fresh air rotary flap.

According to a first adjustment combination, the fresh air rotary flap can be in the first closed position, the circulating air rotary flap being in an open position. This first adjustment combination of the fresh air rotary flap and the circulating air rotary flap corresponds to the operating mode of circulating air operation.

According to a second adjustment combination, the fresh air rotary flap can be in a throttled position, the circulating air rotary flap being in a throttled position. This second adjustment combination of the fresh air rotary flap and the circulating air rotary flap corresponds to the operating mode of partial air operation, in which a mixture of circulating air and fresh air is provided. A dynamic pressure compensation in the partial air operation can be achieved by shifting the cross-sectional ratios with reduction of the cross section for the fresh air.

According to a third adjustment combination, the fresh air rotary flap can be in an open position or throttled position, the circulating air rotary flap being in a closed position. This third adjustment combination of the fresh air rotary flap and the circulating air rotary flap corresponds to the operating mode of fresh air operation.

According to a fourth adjustment combination, the fresh air rotary flap can be in a throttled position, the circulating air rotary flap being in a closed position. This fourth adjustment combination of the fresh air rotary flap and the circulating air rotary flap corresponds to the operating mode of dynamic pressure compensation operation.

According to a fifth adjustment combination, the fresh air rotary flap can be in a throttled position or nearly closed position, the circulating air rotary flap being in a closed position. This fifth operating mode corresponds to a maximum dynamic pressure compensation.

Additionally, a sixth adjustment combination of the rotary flaps can be provided, in which the fresh air rotary flap is in the second closed position, the circulating air rotary flap being in a closed position. This sixth adjustment combination of the fresh air rotary flap and the circulating air rotary flap corresponds to the operating mode of everything closed, which corresponds to a switched-off state of the HVAC unit as the air supply is interrupted. The sixth adjustment combination is provided for transporting the HVAC unit, for example.

Furthermore, the subject-matter of the invention is a heating, ventilation and air-conditioning unit (HVAC unit) in which the flap system according to the invention is used in a motor vehicle for circulating-air/fresh-air control in the motor vehicle.

Additional aspects and advantages of the invention:

In the known prior solutions, the cam disc or the link disc is often sized to be larger than the bolt hole pattern of the actuator. Therefore, a carrier plate for receiving the actuator is employed for receiving the actuator. According to the invention, the link disc has only a single guide track. As the link disc has only a single guide track, the sliding disc can be designed in a compact manner. As a result, the size of the link disc is not in conflict with the bolt hole pattern of the actuator. A carrier plate for the actuator can thus be omitted, which allows to save costs and installation space. This contributes to the desired compact design of a HVAC system for a motor vehicle.

The possibility of precise positioning of the fresh air rotary flap allows to achieve precise dynamic pressure compensation.

The drive with only one actuator is cost-effective and space-saving.

The flap system according to the invention causes less noise during adjustment and the setting accuracy of adjustment of the fresh air rotary flap and the circulating air rotary flap is comparable to known solutions.

### DESCRIPTION OF DRAWINGS

Further details, features, and advantages of embodiments of the invention will become apparent from the following description of exemplary embodiments with reference to the accompanying drawings. In the drawings:

FIG. 1: shows a schematic diagram of a first exemplary embodiment of the flap system according to the invention for an HVAC unit,

FIG. 2: shows a schematic diagram of a second exemplary embodiment of the flap system according to the invention for an HVAC unit,

FIG. 3: shows a schematic diagram of a third exemplary embodiment of the flap system according to the invention for an HVAC unit,

FIG. 4: shows a schematic diagram of an exemplary embodiment of a flap arrangement of the flap system according to the invention in a housing part of an HVAC unit,

FIG. 5: shows a perspective schematic diagram of an exemplary embodiment of the cam gear of the flap system according to the invention,

FIG. 6: shows a further schematic diagram of an exemplary embodiment of the cam gear as a detail section,

FIG. 7: shows multiple diagrams a) to h) of the fresh air rotary flap and the circulating air rotary flap for explaining the functional principle of the flap system according to the invention, and

FIG. 8: shows a schematic diagram of a further exemplary embodiment of the flap system according to the invention with a modified flap arrangement.

### DESCRIPTION OF AN EMBODIMENT

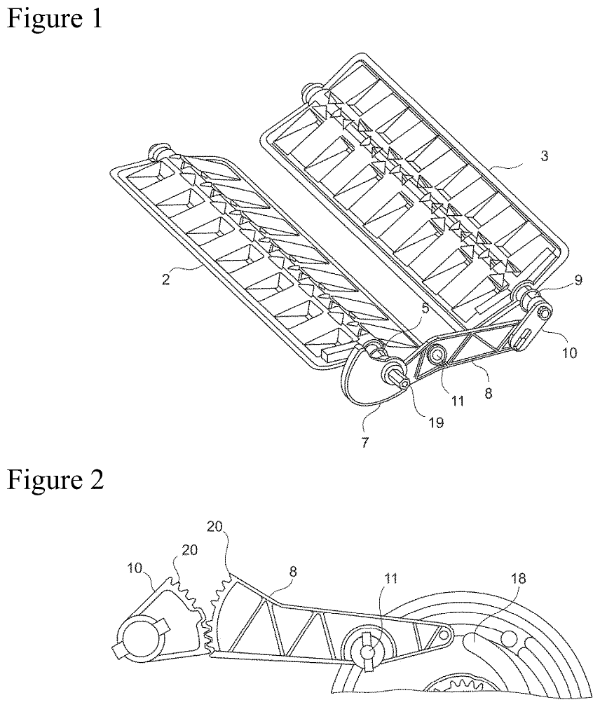

FIG. 1 shows a schematic diagram of an exemplary embodiment of the flap system 1 according to the invention for an HVAC unit for circulating-air/fresh-air control in a motor vehicle. The diagram shows only the components of the flap system 1 in their operative connection, the housing of the HVAC unit not being shown. The flap system 1 has two rotary flaps 2 and 3, wherein the rotary flap 2, as a fresh air rotary flap, is associated with a flow duct (not shown) for fresh air for influencing a fresh air flow in the HVAC unit, and wherein the rotary flap 3, as a circulating air rotary flap, is associated with a flow duct (not shown) for circulating air for influencing a circulating air flow in the HVAC unit. The drive shaft of the rotary flap 2 is denoted with the reference numeral 5, the drive shaft of the rotary flap 3 being denoted with the reference numeral 9. By rotating the drive shafts 5 and 9, the rotary flaps 2 and 3 are adjustable about an axis of rotation in the flow ducts. By adjusting the rotary flaps, the flow cross section in the flow ducts is modified.

A further component of the flap system 1 is a cam gear 6 mechanically coupling the rotary flaps 2 and 3, which has a cam disc 7 coupled to the shaft 5 and having a guide track 18 in which a pendulum lever 8 mechanically coupled to a drive lever 10 of the rotary flap 3 is guided in such a way that a rotation of the cam disc 7 effects an indirect drive for adjusting the rotary flap 3. As such, the rotary flap 2 can be moved between a first closed position and a second closed position into an open position, wherein the rotary flap 3 is movable between a closed position and an open position.

The pendulum lever 8 is rotatable about a pivot point 11 at which the pendulum lever 8 is mounted. Furthermore, the pendulum lever 8 is mechanically coupled to the drive lever 10 connected to the drive shaft 9 of the rotary flap 3 in an articulated manner. The articulated connection between the pendulum lever 8 and the drive lever 10, which can also be referred to as a flap lever, is designed as a pin-groove connection, wherein a pin of the pendulum lever 8 is guided in a groove of the drive lever 10. Because of the articulated connection between the pendulum lever 8 and the second drive lever 10, when the pendulum lever 8 is adjusted about the pivot point 11, a rotation is transmitted to the drive shaft 9, thereby adjusting the rotary flap 3 coupled to the drive shaft 9. Thus, the rotary flap 3 is adjustable without its own actuator as a function of an adjustment of the rotary flap 2.

An actuator 4, not shown in FIG. 1, for directly driving the rotary flap 2 is also a component of the flap system 1. The actuator 4 is coupled to the drive shaft 5 at a pin 19 at the end of the drive shaft 5, at which the cam disc 7 is arranged. In a further embodiment of the flap system 1 (not shown), the actuator 4 is coupled to the drive shaft 5 at an opposite end of the drive shaft 5, so that the actuator 4 is arranged opposite the cam disc 7.

FIG. 2 shows a schematic diagram of a second exemplary embodiment of the flap system 1 according to the invention for an HVAC unit. In this embodiment of the flap system 1, the mechanical coupling between the pendulum lever 8, which is guided with a pin in the guide track 18 of the cam disc 7, and the drive lever 10 of the rotary flap 3 is designed as interlocking toothing. As such, the respective opposite end faces of the pendulum lever 8 and the drive lever 10 are designed with teeth 20 which interlock to transmit force between the pendulum lever 8 and the drive lever 10.

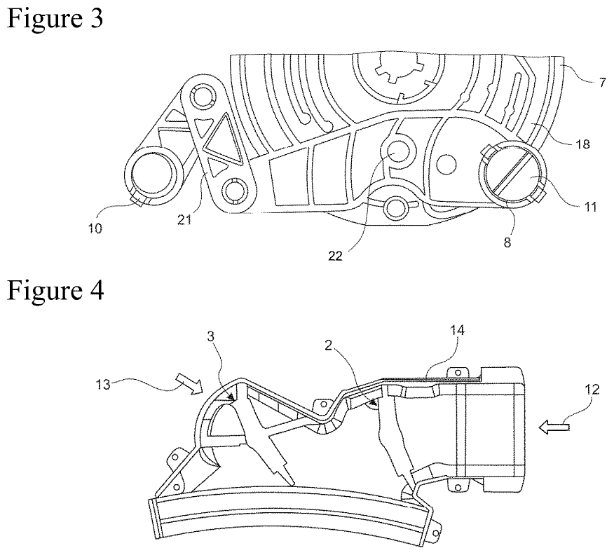

FIG. 3 shows a schematic diagram of a third exemplary embodiment of the flap system according to the invention for an HVAC unit. In this embodiment of the flap system 1, the mechanical coupling between the pendulum lever 8 and the drive lever 10 of the rotary flap 3 is in the form of an articulated connection with an additional coupling 21. The articulated connection thus formed has four pivot points, thereby enabling further structurally advantageous arrangements of the rotary flaps 2 and 3. The reference numeral 22 denotes the position of the pin formed on the pendulum lever 8, which is guided in a guide track of the cam disc 7, but is concealed by the pendulum lever 8 in the diagram shown. In use, the pendulum lever 8 oscillates about the pivot point 11.

FIG. 4 shows a schematic diagram of an exemplary embodiment of a flap arrangement of the flap system 1 according to the invention in a housing part 14 of an open HVAC unit. Thus, FIG. 4 shows a view into the interior of the HVAC unit. The components of the cam gear 6 are not shown. The rotary flaps 2 and 3, of which the rotary flap 2 is designed as a fresh air rotary flap and the rotary flap 3 is designed as a circulating air rotary flap 3, are arranged in the housing part 14 in such a way that they do not touch when the adjustment position changes. The arrow denoted with the reference numeral 12 shows the direction of flow of the fresh air flow. The arrow 13 denotes the direction of flow of the circulating air flow of the air from the vehicle interior. In the adjustment combination shown, the fresh air rotary flap is in a closed position, so that a fresh air supply is interrupted, the circulating air rotary flap being in an open position. This corresponds to the operating mode of circulating air operation.

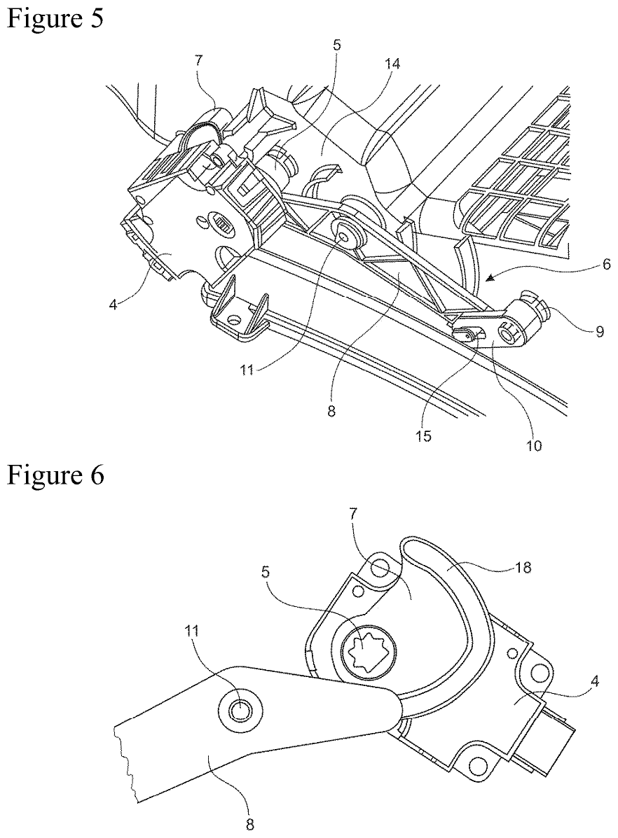

FIG. 5 shows a perspective schematic diagram of an exemplary embodiment of the cam gear 6 of the flap system 1 according to the invention. It shows the components of the cam gear 6, which are arranged outside the HVAC unit on the housing part 14. The actuator 4 is coupled to the drive shaft 5 by placing the actuator on the pin 19 of the drive shaft 5. The drive shaft 5 drives the fresh air rotary flap (not shown) arranged in the interior of the housing part 14. What is also coupled to the drive shaft 5 is the cam disc 7, which has a guide track in which a pin of the pendulum lever 8 is guided. The pendulum lever 8 is rotatably mounted on the housing part 14 about a pivot point 11. Furthermore, the pendulum lever 8 is connected to the drive lever 10 by means of an articulated connection, wherein the drive lever 10 is connected to the drive shaft 9 by means of a pin. The drive shaft 9 is coupled directly to the circulating air rotary flap (not shown) arranged in the interior of the housing part 14, so that a rotation of the drive shaft 9 effects an adjustment of the circulating air rotary flap. The articulated connection between the pendulum lever 8 and the drive lever 10 has a guide groove 15 to compensate for the change in position of the adjusting levers during adjustment or to avoid jamming. Such an articulated connection may also be referred to as a pin-groove connection. The drive shafts 5 and 9 are received and supported by the housing wall of the housing part 14. The compact cam disc 7 does not come into conflict with the screw connection points of the actuator 4. As a result, the actuator 4 is advantageously screwed to the housing part 14 without a separate carrier plate being required for receiving the actuator 4.

FIG. 6 shows a further schematic diagram of an exemplary embodiment of the cam gear 6 as a detail section. The detail section shows the view of the cam gear 6 from the side facing away from the housing part 14. What can be seen are the actuator 4, the drive shaft 5, the cam disc 7 coupled to the drive shaft 5, in which a guide track 18 is formed, and the pendulum lever 8, which is guided with a pin in the guide track 18. The pendulum lever 8 is rotatable about the pivot point 11. The course of the guide track 18 is designed in such a way that the pendulum lever 8 is adjusted to a predetermined angle about the pivot point 11 when the cam disc 7 rotates. The actuator 4 drives the drive shaft 5 and the cam disc 7 located on the drive shaft 5. This effects a direct drive of the rotary flap 2 and an indirect drive of the rotary flap 3.

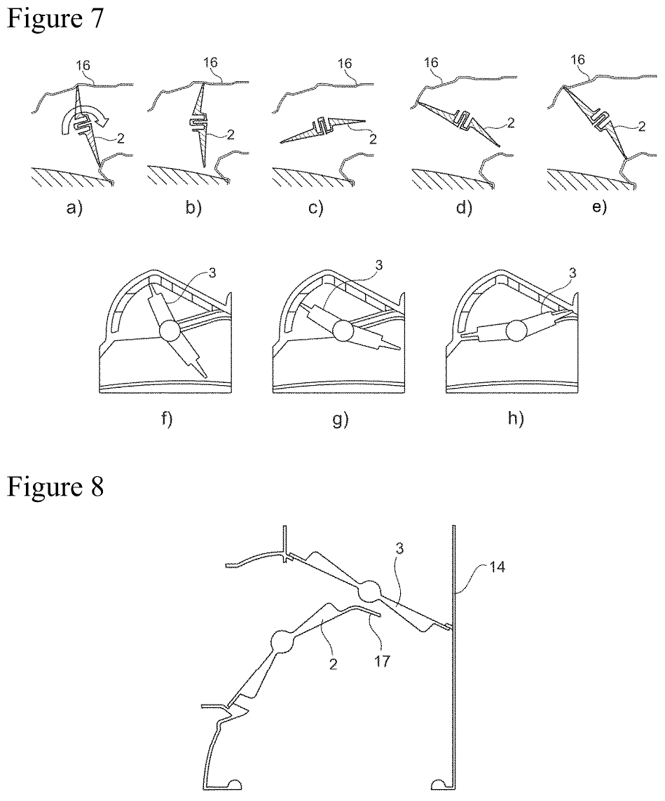

FIG. 7 shows multiple diagrams a) to h) of the rotary flap 2 designed as a fresh air rotary flap and the rotary flap 3 designed as a circulating air rotary flap for explaining the functional principle of the flap system 1 according to the invention. As such, panels a) to e) show different positions of the fresh air rotary flap arranged in a fresh air flow duct 16. Panels f) to h) show positions of the circulating air rotary flap, wherein the cam gear 6 causes the positions of the circulating air flap to depend on the positions of the fresh air rotary flap 2. The arrows denote the direction of rotation of the respective rotary flap. The rotary flap 2 is geometrically adapted to the flow duct and is designed in such a way that the rotary flap 2 is movable between two closed positions. The rotary flap 3 is geometrically adapted to the flow duct and is designed in such a way that the rotary flap 3 is movable between a closed position and an open position.

Panel a) shows a position of the fresh air rotary flap in a closed position. The position of the circulating air rotary flap corresponding to the adjustment position of the fresh air rotary flap shown in panel a) is shown in panel f), the circulating air rotary flap being in an open position. This first adjustment combination of the fresh air rotary flap and the circulating air rotary flap corresponds to the operating mode of circulating air operation.

Panel b) shows the fresh air rotary flap in a throttled position. The adjustment position of the fresh air rotary flap shown in panel b) corresponds to the position of the circulating air rotary flap in panel g), the circulating air rotary flap being in throttled position. This second adjustment combination of the fresh air rotary flap and the circulating air rotary flap corresponds to an operating mode of partial air operation, in which a mixture of circulating air and fresh air is provided.

Panel c) shows the fresh air rotary flap in an open position. The adjustment position of the fresh air rotary flap shown in panel c) corresponds to the position of the circulating air rotary flap in panel h), the circulating air rotary flap being in a closed position. This third adjustment combination of the fresh air rotary flap and the circulating air rotary flap corresponds to the operating mode of fresh air operation.

Panel d) shows the fresh air rotary flap in a throttled position. The throttled position effects throttling of the fresh air flow through the fresh air flow duct 16. The adjustment position of the fresh air rotary flap 2 shown in panel d) corresponds to the position of the circulating air rotary flap in panel h), the circulating air rotary flap being in a closed position. This fourth adjustment combination of the fresh air rotary flap and the circulating air rotary flap corresponds to an operating mode of dynamic pressure compensation operation.

Panel e) shows the fresh air rotary flap in a closed position. The closed position effects an interruption of the fresh air flow through the fresh air flow duct 16. The adjustment position of the fresh air rotary flap shown in panel e) corresponds to the position of the circulating air rotary flap in panel h), the circulating air rotary flap being in a closed position. This fifth adjustment combination of the fresh air rotary flap and the circulating air rotary flap corresponds to an operating mode in which an air flow through the flow ducts is interrupted. This corresponds to a switched-off state of the HVAC unit.

The transition from the “circulating air” operating mode to “partial air” and to “fresh air” is smooth and covers the different partial air ratios and the required dynamic pressure compensation.

FIG. 8 shows a schematic diagram of a further exemplary embodiment of the flap system 1 according to the invention with a modified flap arrangement. In this exemplary embodiment, the rotary flaps 2 and 3 in the housing part 14 of the HVAC unit are arranged spatially relative to one another in a space-saving manner in such a way that the rotary flap 2 nearly closes against the rotary flap 3, the fresh air flow being throttled. The rotary flap 2 has a blade 17, which is a sealed end with which the rotary flap 2 closes against the rotary flap 3. The flap system is shown in an operating mode with maximum dynamic pressure compensation. An adjustment position in which both rotary flaps 2 and 3 are closed is not provided in this specific use case. In this exemplary embodiment, the cam gear 6 is also designed in such a way that the adjusting combinations of the rotary flaps shown in FIG. 7 are adjustable. Due to the space-saving arrangement of the rotary flaps 2 and 3, the HVAC unit can advantageously be implemented with a particularly compact design.

1-12. (canceled)

13. A flap system for a heating, ventilation and air-conditioning unit (HVAC unit) for circulating-air/fresh-air control in a motor vehicle, the HVAC unit comprising:
flow ducts for circulating air and for fresh air; and
a mixing chamber in which the circulating air and the fresh air are mixed with one another for ventilating a vehicle interior, the flap system further comprising:
two rotary flaps, each adjustable about an axis of rotation; and
an actuator, by which one of the two rotary flaps is driven directly for adjustment, a drive shaft of the one of the two rotary flaps driven directly having a cam disc with a guide track in which a pendulum lever mechanically coupled to a drive lever of one of the two rotary flaps that is not driven directly is guided in such a way that a rotation of the cam disc effects an indirect drive for adjusting the one of the two rotary flaps that is not driven directly, in which case the one of the two rotary flaps driven directly can be moved in each case between a first closed position and a second closed position into an open position wherein the one of the two rotary flaps driven directly is a fresh air rotary flap associated with a flow channel for the fresh air for influencing a fresh air flow and wherein the one of the two rotary flaps that is not driven directly is a recirculating air rotary flap associated with a flow channel for recirculating air for influencing a recirculating air flow.

14. The flap system according to claim 13, wherein a mechanical coupling between the drive lever of the one of the two rotary flaps that is not directly driven and the pendulum lever is designed as interlocking toothing.

15. The flap system according to claim 13, wherein a mechanical coupling between the drive lever of the one of the two rotary flaps that is not directly driven and the pendulum lever is designed as an articulated connection, wherein the articulated connection is a pin-groove connection.

16. The flap system according to claim 15, wherein the mechanical coupling between the drive lever of the one of the two rotary flaps that is not directly driven and the pendulum lever is in the form of an articulated connection with a coupling.

17. The flap system according to claim 13, wherein a course of the guide track effects a translation between an adjusting movement between the one of the two rotary flaps driven directly and the one of the two rotary flaps that is not directly driven.

18. The flap system according to claim 13, wherein the two rotary flaps each have separate drive shafts, wherein the drive shafts are mounted in a wall of the housing of the HVAC unit.

19. The flap system according to claim 18, wherein the cam disc is coupled to one end of one of the drive shafts of the one of the two rotary flaps driven directly, wherein the actuator is arranged at an opposite end of the one of the drive shafts opposite the cam disc.

20. The flap system according to claim 13, wherein the one of the two rotary flaps driven directly and the one of the two rotary flaps that is not directly driven are spatially arranged relative to one another in such a way that the two rotary flaps close against one another in at least one adjustment position in such a way that one of the flow ducts for circulating air and one of the flow ducts for fresh air are closed.

21. The flap system according to claim 18, wherein the drive shafts for the one of the two rotary flaps driven directly and the one of the two rotary flaps that is not directly driven are mounted so as to pass through a wall of the housing of the HVAC unit, wherein the actuator and the cam disc are arranged outside the wall of the housing of the HVAC unit.

22. The flap system according to claim 13, wherein a course of the guide track is determined in such a way that at least six different adjustment combinations of the two rotary flaps are possible.

23. The flap system according to claim 22, wherein according to a first adjustment combination the one of the two rotary flaps driven directly is in the first closed position, the one of the two rotary flaps that is not directly driven being in an open position, according to a second adjustment combination the one of the two rotary flaps driven directly is in a throttled position, the one of the two rotary flaps that is not directly driven being in a throttled position, according to a third adjustment combination the one of the two rotary flaps driven directly is in an open position, according to a fourth adjustment combination, the one of the two rotary flaps driven directly is in the throttled position, the one of the two rotary flaps that is not directly driven being in a closed position, and according to a fifth adjustment combination, the one of the two rotary flaps driven directly is in the second closed position, the one of the two rotary flaps that is not directly driven being in the closed position.

24. A heating, ventilation, air conditioning (HVAC) apparatus comprising the flap system according to claim 13 for use in the motor vehicle for circulating fresh air control in the motor vehicle.
